(19) United States
(12) Patent Application Publication
(10) Pub. No.: US 2025/0307816 A1
(43) Pub. Date: Oct. 2, 2025

(54) SYSTEM AND METHOD FOR PROCESSING RESOURCE INTERACTIONS VIA A DIGITAL CODE-BASED DYNAMIC SWITCHING AND ROUTING MECHANISM

(71) Applicant: BANK OF AMERICA CORPORATION, Charlotte, NC (US)

(72) Inventors: Saurabh Garg, Faridabad (IN); Shailendra Singh, Thane West (IN)

(73) Assignee: BANK OF AMERICA CORPORATION, Charlotte, NC (US)

(21) Appl. No.: 18/623,568

(22) Filed: Apr. 1, 2024

(51) Int. Cl. H04L 9/32; H04L 9/40

(52) U.S. Cl. CPC H04L 9/3226; H04L 63/0428

(57) ABSTRACT

Embodiments of the present invention provide a system for processing resource interactions via a digital code-based dynamic switching and routing mechanism. The system is configured for identifying input of user information into a interaction device by a user to initiate an interaction, bundling the user information and interaction information into a message packet, routing the message packet to an issuer interaction processor and a resource distribution device network and in response receiving a unique digital code and interaction preferences, generating a weblink comprising executable instructions to prompt the user to provide a secret digital code, receive the secret digital code, and instantaneously validate the secret digital code against the unique digital code, displaying the weblink on the interaction device, prompting the user to enter the secret digital code, wherein upon receipt, the weblink performs instantaneously validation of the secret digital code, and initiating resource distribution associated with the interaction.

### BACKGROUND

There exists a need for a system for processing resource interactions via a digital code-based dynamic switching and routing mechanism.

### BRIEF SUMMARY

Embodiments of the present invention address the above needs and/or achieve other advantages by providing apparatuses (e.g., a system, computer program product and/or other devices) and methods for processing resource interactions via a digital code-based dynamic switching and routing mechanism. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies initiation of a resource interaction at a point of interaction device by a user, wherein initiation of the resource interaction comprises input of user information into the point of interaction device, causes the point of interaction device to transmit the user information associated with the resource interaction to an acquirer interaction processor, upon receipt of the user information, causes the acquirer interaction processor to: (a) bundle the user information and resource interaction information, via a control object driven algorithm; (b) generate a message packet comprising the bundle, via the control object driven algorithm; and (c) transmit the message packet via a dynamic routing switch to a control object processor, routes the message packet via the control object processor to at least one of an issuer interaction processor and a resource distribution device network, wherein the issuer interaction processor and the resource distribution device network are associated with the user, receives a unique digital code and interaction preferences from at least one of the issuer interaction processor and the resource distribution device network, via the control object processor, transmits the unique digital code and the interaction preferences to the dynamic routing switch associated with the acquirer interaction processor, via the control object processor, causes the acquirer interaction processor to: (a) generate, via the control object driven algorithm, a weblink comprising a graphical user interface to display on the point of interaction device, wherein the weblink comprises executable instructions to prompt the user to provide a secret digital code, receive the secret digital code, and instantaneously validate the secret digital code against the unique digital code; and (b) transmit the weblink to the point of transaction device, and causes the point of interaction device to (a) display the weblink and the graphical user interface associated with the weblink, wherein the graphical user interface prompts the user to enter the secret digital code, wherein the weblink perform instantaneously validation of the secret digital code and (b) initiate resource distribution associated with the resource interaction based on instantaneous validation of the secret digital code.

In some embodiments, the weblink is active for a predetermined amount of time.

In some embodiments, generating the message packet comprises encrypting the user information and resource interaction information by an encryption standard that can be comprehended by the acquirer interaction processor, the control object processor, the issuer interaction processor, and the resource distribution device network.

In some embodiments, the present invention onboard the user, wherein onboarding the user comprises prompting the user to provide the secret digital code on a user device of the user, receiving the secret digital code from the user device, linking the secret digital code with the user information of the user, prompting the user to provide the interaction preferences associated with the secret digital code, receiving the interaction preferences from the user device, and linking the interaction preferences with the secret digital code.

In some embodiments, the present invention transmits the at least one of secret digital code linked with the user information and the interaction preferences linked with the digital code to the issuer interaction processor and the resource distribution device network.

In some embodiments, the interaction preferences comprise at least one of usage of one or more resource distribution devices for different types of interactions, interaction geofencing preferences, product preferences, service preferences, timing preferences, and merchant preferences.

In some embodiments, the present invention transmits one or more real-time executable instructions associated with processing of the resource interaction to the acquirer interaction processor, the issuer interaction processor, and the resource distribution device network.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for processing resource interactions via a digital code-based dynamic switching and routing mechanism, in accordance with an embodiment of the invention;

FIG. 2 provides a block diagram illustrating the issuer interaction processing system 200 of FIG. 1, in accordance with an embodiment of the invention;

FIG. 3 provides a block diagram illustrating a resource interaction processing system 300 of FIG. 1, in accordance with an embodiment of the invention;

FIG. 4 provides a block diagram illustrating the computing device system 400 of FIG. 1, in accordance with an embodiment of the invention;

FIGS. 5A and 5B provide a process flow for processing resource interactions via a digital code-based dynamic switching and routing mechanism, in accordance with an embodiment of the invention; and

FIG. 6 provides a block diagram illustrating the process of processing resource interactions via a digital code-based dynamic switching and routing mechanism, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

A “transaction” or “resource distribution” or “interaction” or “resource interaction” refers to any communication between a user, a financial institution, and/or another entity (e.g., a merchant) to transfer resources (e.g., funds, credit, and/or the like) for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, a point-of-transaction device (POT) may be or include a merchant machine and/or server and/or may be or include the mobile device of the user, which may function as a point of transaction device. The embodiments described herein may refer to the use of a transaction, transaction event or point of transaction event to trigger the steps, functions, routines or the like described herein. In various embodiments, occurrence of a transaction triggers the sending of a distribution request or transaction request including information identifying a resource distribution device (e.g., a payment card, such as a credit card, debit card, gift card, and/or the like, a mobile device running an electronic payment operation, such as a remote wallet, an near-field communication (NFC) based payment, and/or the like). As used herein, a “resource pool” or “bank account” refers to a credit account, a debit/deposit account, and/or the like comprising resources (e.g., funds). Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, and/or the like. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device.” A “point-of-transaction” may refer to any location, virtual location or otherwise proximate occurrence of a transaction. A “point-of-transaction device” or “resource distribution device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. In some embodiments, a point-of-transaction device and/or a resource distribution device may be or may include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal global positioning system (GPS) device, or the like), a merchant terminal, a self-service machine (e.g., vending machine, self-checkout machine, or the like), a public and/or business kiosk (e.g., an Internet kiosk, ticketing kiosk, bill pay kiosk, or the like), an entertainment device, and/or various combinations of the foregoing.

Further, the term “payment credential,” “payment vehicle,” and/or “resource distribution device” as used herein, may refer to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the resource distribution device is a bank card issued by a bank which a customer may use to perform purchase transactions. However, in other embodiments, the resource distribution device is a virtual debit card housed in a mobile device of the customer, which can be used to electronically interact with an ATM or the like to perform financial transactions. Thus, it will be understood that the resource distribution device can be embodied as an apparatus (e.g., a physical card, a mobile device, or the like), or as a virtual transaction mechanism (e.g., a digital transaction device, digital wallet, a virtual display of a transaction device, or the like). The resource distribution device may be an unrestricted resource. Unrestricted resources, as used herein may be any resource that is not restricted for transaction. In this way, the unrestricted resources may be applied to any transaction for purchase of a product or service.

In some embodiments, an “entity” may refer to a financial institution. In some embodiments, a “financial institution” may be any organization, entity, or the like in the business of moving, investing, or lending money, dealing in financial instruments, or providing financial services. This may include commercial banks, thrifts, federal and state savings banks, savings and loan associations, credit unions, investment companies, insurance companies, and/or the like. In some embodiments, a financial institution may allow a user to establish an account with the financial institution. An “account” may be the relationship that the user has with the financial institution. Examples of accounts include a deposit account, such as a transactional account (e.g., a banking account), a savings account, an investment account, a money market account, a time deposit, a demand deposit, a pre-paid account, a credit account, a non-monetary user account that includes only personal information associated with the user, and/or the like. The account is associated with and/or maintained by the financial institution. In other embodiments, an entity may not be a financial institution. In still other embodiments, the entity may be the merchant itself. In some embodiments, the “user” may be a customer (e.g., an account holder or a person who has a third party mobile wallet system associated with his/her mobile device). In some other embodiments, the entity may be any entity involved in processing of the transactions. Examples of such entities may include, but are not limited, user financial institution, merchant financial institution, merchant, payment issuers, payment acquirers, card networks, third party payment processors, and/or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to develop, access, and/or use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Current point of interaction devices do not allow users to perform interactions without a resource distribution device (e.g., credit card) and user devices (e.g., mobile device). As such, there exists a system that allows users to perform resource interactions without the resource distribution device and user devices at point of interaction devices.

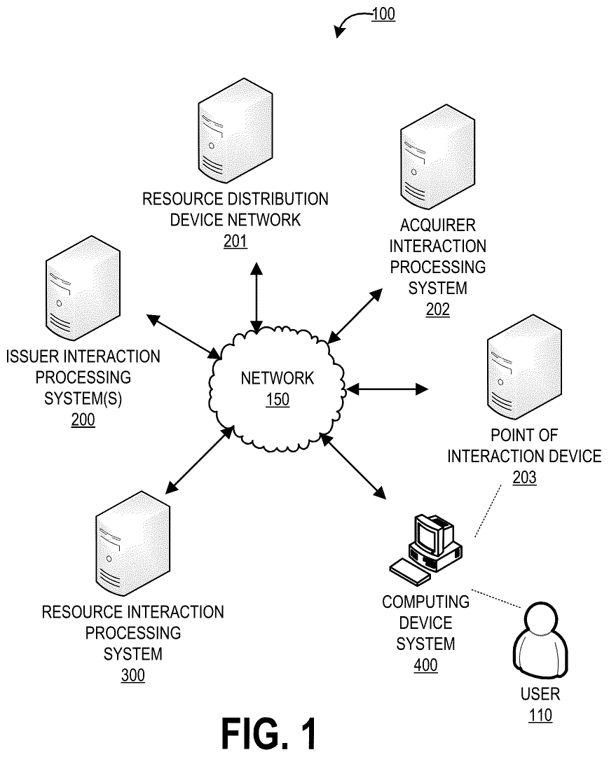

FIG. 1 provides a block diagram illustrating a system environment 100 for processing resource interactions via a digital code-based dynamic switching and routing mechanism, in accordance with an embodiment of the invention. As illustrated in FIG. 1, the environment 100 includes a resource interaction processing system 300, an issuer interaction processing system 200, a resource distribution device network 201, an acquirer interaction processing network 202, a point of interaction device 203, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the issuer interaction processing system 200. In some embodiments, the one or more user(s) 110 of the system environment 100 may be potential customers of the entity associated with the issuer interaction processing system 200.

The issuer interaction processing system(s) 200, the resource distribution device network 201, and the acquirer interaction processing system 202 may be any systems owned or otherwise controlled by an entity to support or perform processing of resource interactions described herein. In some embodiments, the issuer interaction processing system(s) 200 may be a financial institution maintaining and/or managing one or more resource pools (e.g., checking account, savings account, credit card account, and/or the like) of the user. In an exemplary embodiment, the issuer interaction processing system 200 may be issuer of a credit card to the user 110. In some embodiments, the resource distribution device network 201 may be a financial network that provides communication between issuer interaction processing system 200, one or more third party entities (e.g., merchants), and acquirer interaction processing systems 202 associated with the one or more third party entities. For example, the resource distribution device network may be a card network. In some embodiments, the acquirer interaction processing system 202 may be a financial institution associated with a third party entity (e.g., merchants) that provide goods, services, and/or the like to the users 110. In some embodiments, the point of interaction devices 203 may be point of sale devices located at one or more third party entity locations associated with the one or more third party entities for processing resource interactions.

The resource interaction processing system 300 is a system of the present invention for performing one or more process steps described herein. In some embodiments, the resource interaction processing system 300 may be an independent system. In some embodiments, the resource interaction processing system 300 may be associated with an entity that is associated with the issuer interaction processing system(s) 200, the resource distribution device network 201, and/or the acquirer interaction processing system 202.

The resource interaction processing system 300, the issuer interaction processing system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource interaction processing system 300 is configured to communicate information or instructions with the issuer interaction processing system 200, and/or the computing device system 400 across the network 150.

The computing device system 400 may be a computing device of the user 110. In some embodiments of the invention, the computing device system 400 may act as the point of interaction device 203 (e.g., for online transactions initiated by the user via the computing device system 400). In general, the computing device system 400 communicates with the user 110 via a user interface of the computing device system 400, and in turn is configured to communicate information or instructions with the resource interaction processing system 300 and/or issuer interaction processing system 200 across the network 150.

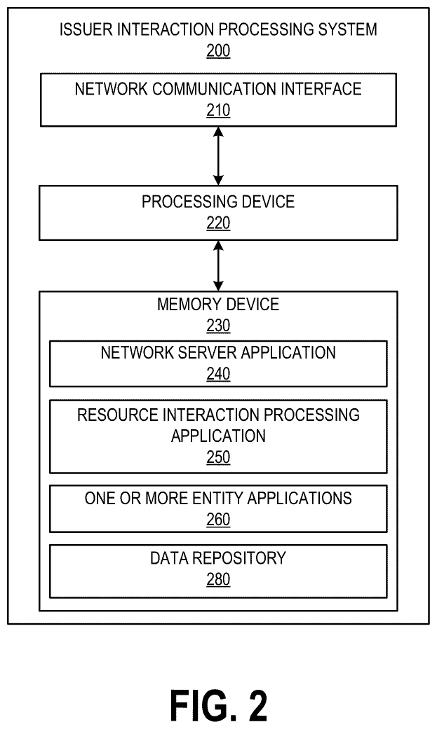

FIG. 2 provides a block diagram illustrating the issuer interaction processing system 200, in greater detail, in accordance with embodiments of the invention. The resource distribution device network 201, the acquirer interaction processing system 202, and the point of interaction devices 203 may also have the same structure and components as shown in the block diagram 200. As illustrated in FIG. 2, in one embodiment of the invention, the issuer interaction processing system 200 includes one or more processing devices 220 operatively coupled to a network communication interface 210 and a memory device 230. In certain embodiments, the issuer interaction processing system 200 is operated by an entity, such as a financial institution, while in other embodiments, the issuer interaction processing system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the issuer interaction processing system 200 described herein. For example, in one embodiment of the issuer interaction processing system 200, the memory device 230 includes, but is not limited to, a network server application 240, a resource interaction processing application 250, one or more entity applications 260, and a data repository 280. The computer-executable program code of the network server application 240, the resource interaction processing application 250, and the one or more entity applications 260 to perform certain logic, data-extraction, and data-storing functions of the issuer interaction processing system 200 described herein, as well as communication functions of the issuer interaction processing system 200.

The network server application 240, the resource interaction processing application 250, and the one or more entity applications 260 are configured to store data in the data repository 280 or to use the data stored in the data repository 280 when communicating through the network communication interface 210 with the resource interaction processing system 300, and the computing device system 400 to perform one or more process steps described herein. In some embodiments, the issuer interaction processing system 200 may receive instructions from the resource interaction processing system 300 via the resource interaction processing application 250 to perform certain operations. The resource interaction processing application 250 may be provided by the resource interaction processing system 300.

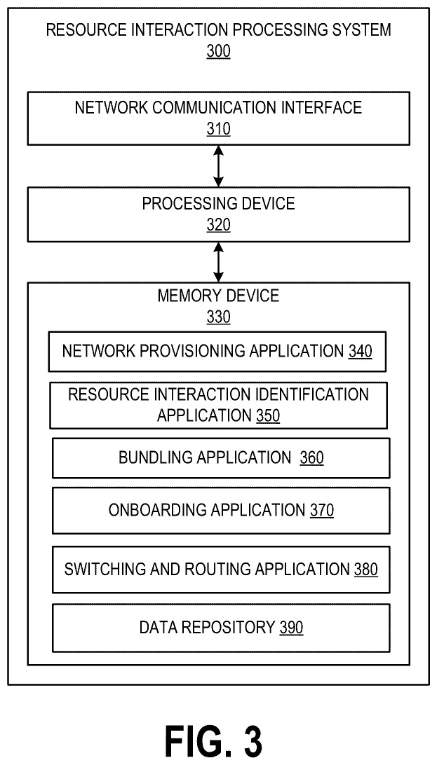

FIG. 3 provides a block diagram illustrating the resource interaction processing system 300 in greater detail, in accordance with embodiments of the invention. As illustrated in FIG. 3, in one embodiment of the invention, the resource interaction processing system 300 includes one or more processing devices 320 operatively coupled to a network communication interface 310 and a memory device 330. In certain embodiments, the resource interaction processing system 300 is operated by an entity, such as a financial institution, while in other embodiments, the resource interaction processing system 300 is operated by an entity other than a financial institution. In some embodiments, the resource interaction processing system 300 is owned or operated by the entity of the issuer interaction processing system 200, the resource distribution device network 201, and/or the acquirer interaction processing system 202. In some embodiments, the resource interaction processing system 300 may be an independent system. In alternate embodiments, the resource interaction processing system 300 may be a part of any one of the issuer interaction processing system 200, the resource distribution device network 201, and/or the acquirer interaction processing system 202.

It should be understood that the memory device 330 may include one or more databases or other data structures/repositories. The memory device 330 also includes computer-executable program code that instructs the processing device 320 to perform one or more data processing operations and to operate the network communication interface 310 to perform certain communication functions of the resource interaction processing system 300 described herein. For example, in one embodiment of the resource interaction processing system 300, the memory device 330 includes, but is not limited to, a network provisioning application 340, a resource interaction identification application 350, a bundling application 360, an onboarding application 370, a switching and routing application 380, and a data repository 390 comprising data processed or accessed by one or more applications in the memory device 330. The computer-executable program code of the network provisioning application 340, the resource interaction identification application 350, the bundling application 360, the onboarding application 370, and the switching and routing application 380 may instruct the processing device 320 to perform certain logic, data-processing, and data-storing functions of the resource interaction processing system 300 described herein, as well as communication functions of the resource interaction processing system 300.

The network provisioning application 340, the resource interaction identification application 350, the bundling application 360, the onboarding application 370, and the switching and routing application 380 are configured to invoke or use the data in the data repository 390 when communicating through the network communication interface 310 with the issuer interaction processing system 200, and the computing device system 400. In some embodiments, the network provisioning application 340, the resource interaction identification application 350, the bundling application 360, the onboarding application 370, and the switching and routing application 380 may store the data extracted or received from the issuer interaction processing system 200 and the computing device system 400 in the data repository 390. In some embodiments, the network provisioning application 340, the resource interaction identification application 350, the bundling application 360, the onboarding application 370, and the switching and routing application 380 may be a part of a single application. In some embodiments, each of the resource interaction identification application 350, the bundling application 360, the onboarding application 370, and the switching and routing application 380 may perform one or more data processing operations, generate instantaneous executable instructions and transmit them to the issuer interaction processing system 200, the resource distribution device network 201, the acquirer interaction processing system 202, the point of interaction devices 203, and/or the computing device system 400. One or more processes performed by the network provisioning application 340, the resource interaction identification application 350, the bundling application 360, the onboarding application 370, and the switching and routing application 380 are described in detail below.

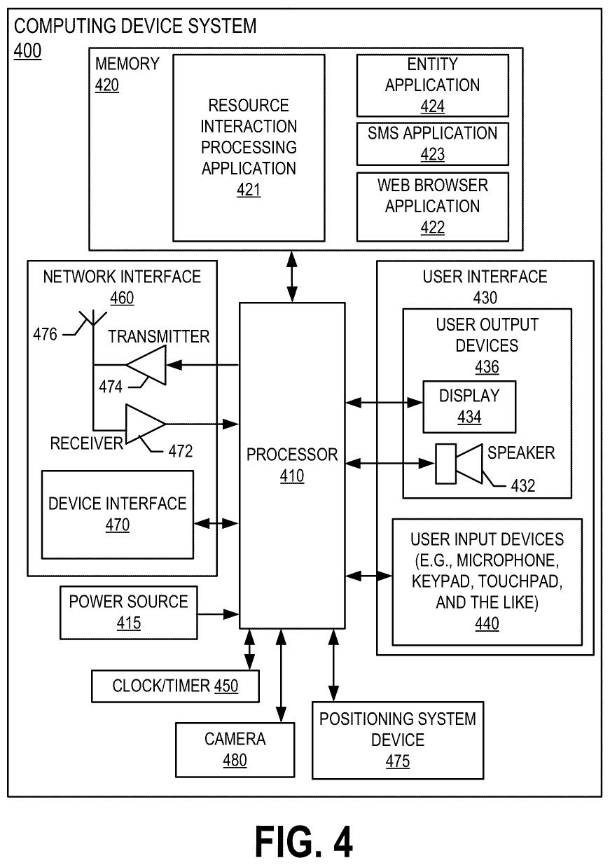

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource interaction processing application 421, an entity application 424, or the like. These applications also typically instructions to a graphical user interface (GUI) on the display 430 that allows the user 110 to interact with the issuer interaction processing system 200, the resource interaction processing system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

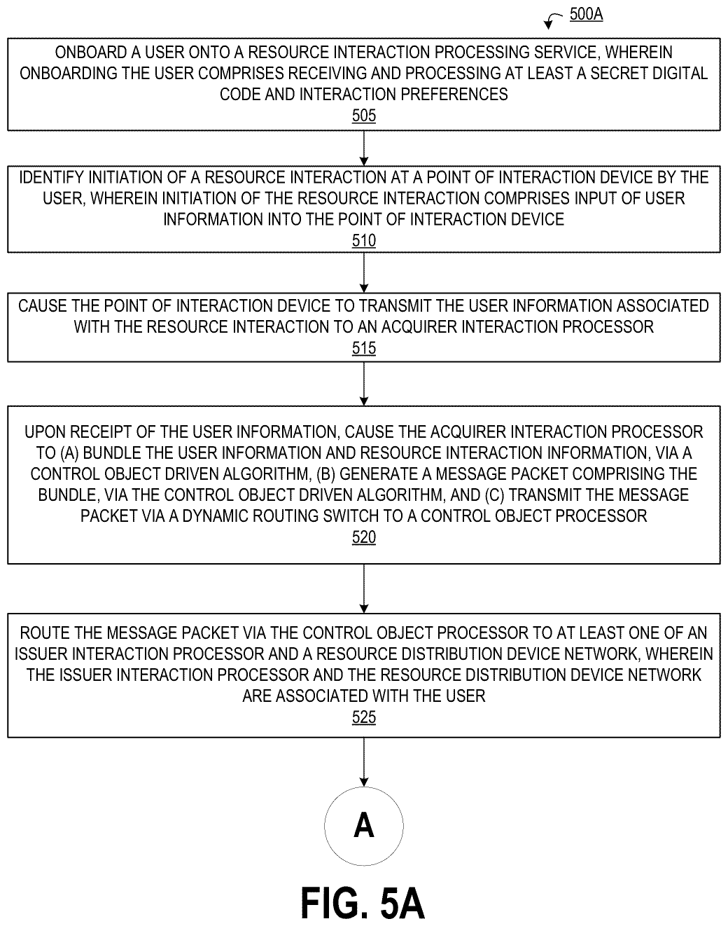

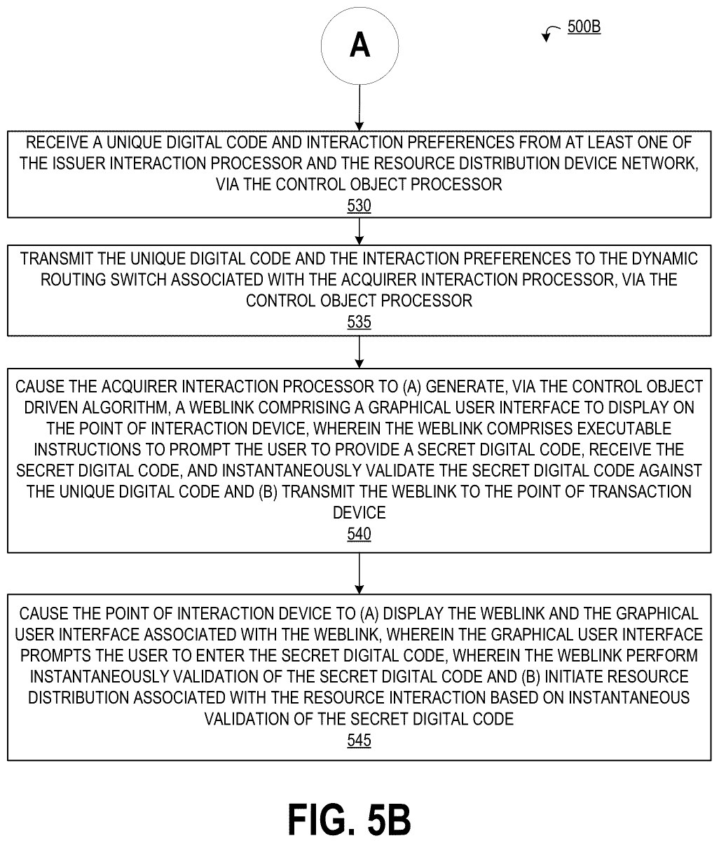

FIGS. 5A and 5B provide a process flow for processing resource interactions via a digital code-based dynamic switching and routing mechanism, in accordance with an embodiment of the invention. As shown in block 505, the system onboards a user onto a resource interaction processing service, wherein onboarding the user comprises receiving and processing at least a secret digital code and interaction preferences. Onboarding of the user may be performed via an onboarding graphical user interface provided by the system. In some embodiments, onboarding the user comprises prompting the user to provide a secret digital code on a user device of the user, receiving the secret digital code from the user device, linking the secret digital code with user information of the user. In some embodiments, the secret digital code may be an alphanumeric code, numeric code, alphabet code, a combination of special characters with alphanumeric, numeric, or alphabet codes, and/or the like. In some embodiments, the system may link the secret digital code with the user information of the user based on extracting the user information from the any of the resource processing systems described in FIG. 1. In one example, after receiving the secret digital code, the system may associate the secret digital code with phone number of the user. In another example, the system may associate with the secret digital code with an email address of the user. In yet another example, the user may associate the secret digital code with a bank account number of the user. In some embodiments, the system may link the secret digital code with a specific piece of user information based on an input received from the user. For example, the user may specify that the secret digital code be linked with the phone number of the user.

Onboarding the user may further comprise prompting the user to provide the interaction preferences associated with the secret digital code, receiving the interaction preferences from the user device, and linking the interaction preferences with the secret digital code. In some embodiments, interaction preferences may comprise at least one of usage of one or more resource distribution devices for different types of interactions (e.g., use a first credit card for online transaction, use a second credit card at a first merchant, use a third credit card at a second merchant, and/or the like), interaction geofencing preferences (e.g., 5 miles surrounding location ‘A’), product preferences (e.g., used towards purchase of a particular product), service preferences (e.g., used towards purchase of a particular service), timing preferences (e.g., used first week of every month, used between 5-9 pm), and merchant preferences (e.g., used with a specific merchant).

After completion of the onboarding process, the system may transmit the at least one of secret digital code linked with the user information and the interaction preferences linked with the digital code to the issuer interaction processor and the resource distribution device network. In some embodiments, the system may independently perform the onboarding process and may transmit the information to other systems shown in FIG. 1. In some embodiments, the system may cause any of the systems shown in FIG. 1 to onboard the user. In some such embodiments, the system may generate and transmit real-time executable instructions associated with the onboarding process to the system performing the onboarding process.

As shown in block 510, the system identifies initiation of a resource interaction at a point of interaction device by the user, wherein initiation of the resource interaction comprises input of user information into the point of interaction device. For example, the user may enter a mobile phone number at a point of sale device located at a merchant location, where the mobile phone number is the user information that has been used to register in the onboarding process described in block 505. In some embodiments, the system may transmit executable portions of code to the point of interaction device that may either allow the system to monitor one or more resource interactions initiated at the point of interaction devices or cause the point of interaction device to notify the system when resource interactions are initiated at the point of interaction device by one or more users.

As shown in block 515, the system causes the point of interaction device to transmit the user information associated with the resource interaction to an acquirer interaction processor. The acquirer interaction processor may be a financial institution that is associated with a third party entity (e.g., merchant) that is providing goods, services, products, or the like to the user. In some embodiments, the system may also cause the point of interaction device to transmit interaction information (e.g., sales receipt, product data, or the like) associated with the resource interaction.

As shown in block 520, the system upon receipt of the user information, causes the acquirer interaction processor to (a) bundle the user information and resource interaction information, via a control object driven algorithm, (b) generate a message packet comprising the bundle, via the control object driven algorithm, and (c) transmit the message packet via a dynamic routing switch to a control object processor. In some embodiments, the system may transmit executable instructions to the acquirer interaction processor that cause the acquirer interaction processor to perform one or more steps described herein. In some embodiments, generating the message packet comprises encrypting the user information and resource interaction information by an encryption standard that can be comprehended by the acquirer interaction processor, the control object processor, the issuer interaction processor, and the resource distribution device network. The control object driven algorithm transforms the user information and the resource interaction information into a data packet that is compatible with the systems involved with processing resource interactions (e.g., Base24). In some embodiments, the user information and the resource interaction information may be in a tabular format comprising field and values for each field and the control object driven algorithm may encrypt the data in tabular format and may also modify the tabular format to a format that can be read and understood by all of the systems involved in processing resource interactions.

As shown in block 525, the system routes the message packet via the control object processor to at least one of an issuer interaction processor and a resource distribution device network, wherein the issuer interaction processor and the resource distribution device network are associated with the user. As shown in block 530, the system receives a unique digital code and interaction preferences from at least one of the issuer interaction processor and the resource distribution device network, via the control object processor. The issuer interaction processor and the resource distribution device network may validate the message packet, extract information from the message packet (e.g., user information such as mobile phone number), and extract the unique digital code and interaction preferences linked with the user information that were stored in a data repository when transmitted by the system after completion of the onboarding process.

As shown in block 535, the system transmits the unique digital code and the interaction preferences to the dynamic routing switch associated with the acquirer interaction processor, via the control object processor. As shown in block 540, the system causes the acquirer interaction processor to (a) generate, via the control object driven algorithm, a weblink comprising a graphical user interface to display on the point of interaction device, wherein the weblink comprises executable instructions to prompt the user to provide a secret digital code, receive the secret digital code, and instantaneously validate the secret digital code against the unique digital code and (b) transmit the weblink to the point of transaction device. The generated weblink may be active only for a predetermined amount of time. In some embodiments, upon expiration of the predetermined amount of time, the entire process starting from block 515 may have to be repeated to complete the resource interaction.

As shown in block 545, the system causes the point of interaction device to (a) display the weblink and the graphical user interface associated with the weblink, wherein the graphical user interface prompts the user to enter the secret digital code, wherein the weblink perform instantaneously validation of the secret digital code and (b) initiate resource distribution associated with the resource interaction based on instantaneous validation of the secret digital code. In some embodiments, the instantaneous validation may be performed on the point of interaction device by the weblink, where the weblink comprises executable instructions to validate the secret digital code. In some embodiments, the instantaneous validation of the secret digital code may be performed by the point of interaction device based on the instructions received in the weblink or received along with the weblink.

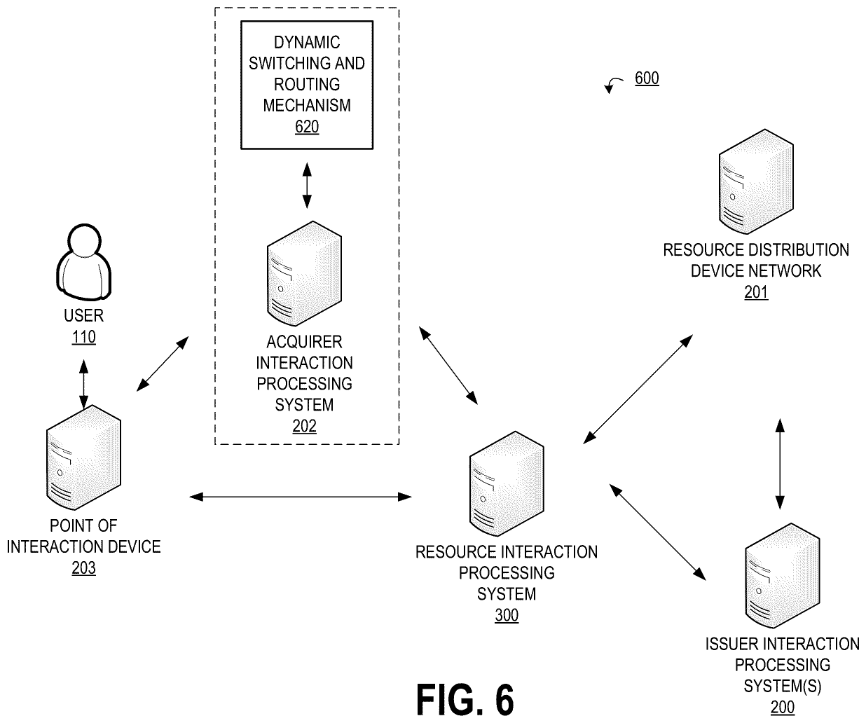

FIG. 6 provides a block diagram illustrating the process of processing resource interactions via a digital code-based dynamic switching and routing mechanism, in accordance with an embodiment of the invention. As shown, the user 110 may initiate a transaction at the point of interaction device 203 by providing user information (e.g., phone number). Executable instructions provided by the system of the invention (referred to as the ‘system’ for the remainder of the description of FIG. 6) that are stored on the point of interaction 203 (or provided by the system in real-time) may cause the point of interaction device 203 to transmit the user information along with the interaction information (e.g., sales receipt, product data, and/or the like) to the system and/or the acquirer interaction processing system 202 comprising a dynamic switching and routing mechanism 620. The dynamic switching and routing mechanism 620 may comprise stored executable instructions provided by the system to perform one or more operations as discussed in FIG. 5. In some embodiments, the dynamic switching and routing mechanism 620 may receive real-time executable instructions from the system to perform the one or more operations. The dynamic switching and routing mechanism 620 may comprise the control object driven algorithm and a dynamic switch used for acquiring, switching, and routing the data associated with the interactions. In some embodiments, the dynamic switch may be a Base24 switch. The acquirer interaction processing system 202 may bundle and package the user information and the interaction information based on performing encryption and may transmit it, via the dynamic switching and routing mechanism 620, to the system comprising the control object processor. The control object processor may comprise the switching and routing application 380 which may route the message packet to at least one of the issuer interaction processing system 200 and the resource distribution device network 201. Upon receipt of the message packet, at least one of the issuer interaction processing system 200 and the resource distribution device network 201 may identify the unique digital code and the interaction preferences linked with the user information and may transmit it back to the control object processor which may then route it to the dynamic switching and routing mechanism 620 of the acquirer interaction processing system 202. The dynamic switching and routing mechanism 620 may generate the weblink comprising the graphical user interface to display on the point of interaction device, wherein the weblink comprises executable instructions to prompt the user to provide a secret digital code, receive the secret digital code, and instantaneously validate the secret digital code against the unique digital code. The acquirer interaction processing system 202 may then transmit the weblink to the point of interaction device 203 which may execute the instructions associated with the weblink to complete the validation of the secret digital code provided by the user. Upon successful validation, the system and/or the point of the interaction 203 may initiate distribution of resources to complete the resource interaction between the user and the merchant.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for processing resource interactions via a digital code-based dynamic switching and routing mechanism, comprising:
at least one processing device;
at least one memory device; and
a module stored in the at least one memory device comprising executable instructions that when executed by the at least one processing device, cause the at least one processing device to:
identify initiation of a resource interaction at a point of interaction device by a user, wherein initiation of the resource interaction comprises input of user information into the point of interaction device;
cause the point of interaction device to transmit the user information associated with the resource interaction to an acquirer interaction processor;
upon receipt of the user information, cause the acquirer interaction processor to:
bundle the user information and resource interaction information, via a control object driven algorithm;
generate a message packet comprising the bundle, via the control object driven algorithm; and
transmit the message packet via a dynamic routing switch to a control object processor;
route the message packet via the control object processor to at least one of an issuer interaction processor and a resource distribution device network, wherein the issuer interaction processor and the resource distribution device network are associated with the user;
receive a unique digital code and interaction preferences from at least one of the issuer interaction processor and the resource distribution device network, via the control object processor;
transmit the unique digital code and the interaction preferences to the dynamic routing switch associated with the acquirer interaction processor, via the control object processor;
cause the acquirer interaction processor to:
generate, via the control object driven algorithm, a weblink comprising a graphical user interface to display on the point of interaction device, wherein the weblink comprises executable instructions to prompt the user to provide a secret digital code, receive the secret digital code, and instantaneously validate the secret digital code against the unique digital code; and
transmit the weblink to the point of interaction device; and
cause the point of interaction device to:
display the weblink and the graphical user interface associated with the weblink, wherein the graphical user interface prompts the user to enter the secret digital code, wherein the weblink perform instantaneously validation of the secret digital code; and
initiate resource distribution associated with the resource interaction based on instantaneous validation of the secret digital code.

2. The system according to claim 1, wherein the weblink is active for a predetermined amount of time.

3. The system according to claim 1, wherein generating the message packet comprises encrypting the user information and the resource interaction information by an encryption standard that can be comprehended by the acquirer interaction processor, the control object processor, the issuer interaction processor, and the resource distribution device network.

4. The system according to claim 1, wherein the executable instructions cause the at least one processing device to onboard the user, wherein onboarding the user comprises:
prompting the user to provide the secret digital code on a user device of the user;
receiving the secret digital code from the user device;
linking the secret digital code with the user information of the user;
prompting the user to provide the interaction preferences associated with the secret digital code;
receiving the interaction preferences from the user device; and
linking the interaction preferences with the secret digital code.

5. The system according to claim 4, wherein the executable instructions cause the at least one processing device to transmit at least one of the secret digital code linked with the user information and the interaction preferences linked with the secret digital code to the issuer interaction processor and the resource distribution device network.

6. The system according to claim 4, wherein the interaction preferences comprise at least one of usage of one or more resource distribution devices for different types of interactions, interaction geofencing preferences, product preferences, service preferences, timing preferences, and merchant preferences.

7. The system according to claim 1, wherein the executable instructions cause the at least one processing device to transmit one or more real-time executable instructions associated with processing of the resource interaction to the acquirer interaction processor, the issuer interaction processor, and the resource distribution device network.

8. A computer program product for processing resource interactions via a digital code-based dynamic switching and routing mechanism, comprising a non-transitory computer-readable storage medium having computer-executable instructions for:
identifying initiation of a resource interaction at a point of interaction device by a user, wherein initiation of the resource interaction comprises input of user information into the point of interaction device;
causing the point of interaction device to transmit the user information associated with the resource interaction to an acquirer interaction processor;
upon receipt of the user information, causing the acquirer interaction processor to:
bundle the user information and resource interaction information, via a control object driven algorithm;
generate a message packet comprising the bundle, via the control object driven algorithm; and
transmit the message packet via a dynamic routing switch to a control object processor;
routing the message packet via the control object processor to at least one of an issuer interaction processor and a resource distribution device network, wherein the issuer interaction processor and the resource distribution device network are associated with the user;
receiving a unique digital code and interaction preferences from at least one of the issuer interaction processor and the resource distribution device network, via the control object processor;
transmitting the unique digital code and the interaction preferences to the dynamic routing switch associated with the acquirer interaction processor, via the control object processor;
causing the acquirer interaction processor to:
generate, via the control object driven algorithm, a weblink comprising a graphical user interface to display on the point of interaction device, wherein the weblink comprises executable instructions to prompt the user to provide a secret digital code, receive the secret digital code, and instantaneously validate the secret digital code against the unique digital code; and
transmit the weblink to the point of interaction device; and
causing the point of interaction device to:
display the weblink and the graphical user interface associated with the weblink, wherein the graphical user interface prompts the user to enter the secret digital code, wherein the weblink perform instantaneously validation of the secret digital code; and
initiate resource distribution associated with the resource interaction based on instantaneous validation of the secret digital code.

9. The computer program product according to claim 8, wherein the weblink is active for a predetermined amount of time.

10. The computer program product according to claim 8, wherein generating the message packet comprises encrypting the user information and the resource interaction information by an encryption standard that can be comprehended by the acquirer interaction processor, the control object processor, the issuer interaction processor, and the resource distribution device network.

11. The computer program product according to claim 8, wherein the non-transitory computer-readable storage medium comprises computer-executable instructions for onboarding the user, wherein onboarding the user comprises:
prompting the user to provide the secret digital code on a user device of the user;
receiving the secret digital code from the user device;
linking the secret digital code with the user information of the user;
prompting the user to provide the interaction preferences associated with the secret digital code;
receiving the interaction preferences from the user device; and
linking the interaction preferences with the secret digital code.

12. The computer program product according to claim 11, wherein the non-transitory computer-readable storage medium comprises computer-executable instructions for transmitting at least one of the secret digital code linked with the user information and the interaction preferences linked with the secret digital code to the issuer interaction processor and the resource distribution device network.

13. The computer program product according to claim 11, wherein the interaction preferences comprise at least one of usage of one or more resource distribution devices for different types of interactions, interaction geofencing preferences, product preferences, service preferences, timing preferences, and merchant preferences.

14. The computer program product according to claim 8, wherein the non-transitory computer-readable storage medium comprises computer-executable instructions for transmitting one or more real-time executable instructions associated with processing of the resource interaction to the acquirer interaction processor, the issuer interaction processor, and the resource distribution device network.

15. A computerized method for processing resource interactions via a digital code-based dynamic switching and routing mechanism, the method comprising:
identifying initiation of a resource interaction at a point of interaction device by a user, wherein initiation of the resource interaction comprises input of user information into the point of interaction device;
causing the point of interaction device to transmit the user information associated with the resource interaction to an acquirer interaction processor;
upon receipt of the user information, causing the acquirer interaction processor to:
bundle the user information and resource interaction information, via a control object driven algorithm;
generate a message packet comprising the bundle, via the control object driven algorithm; and
transmit the message packet via a dynamic routing switch to a control object processor;
routing the message packet via the control object processor to at least one of an issuer interaction processor and a resource distribution device network, wherein the issuer interaction processor and the resource distribution device network are associated with the user;
receiving a unique digital code and interaction preferences from at least one of the issuer interaction processor and the resource distribution device network, via the control object processor;
transmitting the unique digital code and the interaction preferences to the dynamic routing switch associated with the acquirer interaction processor, via the control object processor;
causing the acquirer interaction processor to:
generate, via the control object driven algorithm, a weblink comprising a graphical user interface to display on the point of interaction device, wherein the weblink comprises executable instructions to prompt the user to provide a secret digital code, receive the secret digital code, and instantaneously validate the secret digital code against the unique digital code; and
transmit the weblink to the point of interaction device; and
causing the point of interaction device to:
display the weblink and the graphical user interface associated with the weblink, wherein the graphical user interface prompts the user to enter the secret digital code, wherein the weblink perform instantaneously validation of the secret digital code; and
initiate resource distribution associated with the resource interaction based on instantaneous validation of the secret digital code.

16. The computerized method according to claim 15, wherein the weblink is active for a predetermined amount of time.

17. The computerized method according to claim 15, wherein generating the message packet comprises encrypting the user information and the resource interaction information by an encryption standard that can be comprehended by the acquirer interaction processor, the control object processor, the issuer interaction processor, and the resource distribution device network.

18. The computerized method according to claim 15, wherein the method comprises onboarding the user, wherein onboarding the user comprises:
prompting the user to provide the secret digital code on a user device of the user;
receiving the secret digital code from the user device;
linking the secret digital code with the user information of the user;
prompting the user to provide the interaction preferences associated with the secret digital code;
receiving the interaction preferences from the user device; and
linking the interaction preferences with the secret digital code.

19. The computerized method according to claim 18, wherein the method comprises transmitting at least one of the secret digital code linked with the user information and the interaction preferences linked with the secret digital code to the issuer interaction processor and the resource distribution device network.

20. The computerized method according to claim 18, wherein the interaction preferences comprise at least one of usage of one or more resource distribution devices for different types of interactions, interaction geofencing preferences, product preferences, service preferences, timing preferences, and merchant preferences.
